(19) United States
(12) Patent Application Publication
(10) Pub. No.: US 2003/0091247 A1
(43) Pub. Date: May 15, 2003

(54) Bearing assembly for a bridge

(75) Inventors: Kelson Yen, Taichung (TW); Chen-Chien Hsu, Taichung (TW)

Correspondence Address: GREENBLUM & BERNSTEIN, P.L.C., 1950 ROLAND CLARKE PLACE, RESTON, VA, 20191, US

(73) Assignee: I-STRONG SYSTEMS CO., Ltd.

(21) Appl. No.: 09/986,580

(22) Filed: Nov. 9, 2001

(51) Int. Cl. F16C 41/00

(52) U.S. Cl. 384/36

(57) ABSTRACT

A bearing assembly has a bottom base, a lower plate, an upper plate and a top base. At least one first locking device is configured between the lower plate and the bottom base. At least one second locking device is configured between the upper plate and the top base. Accordingly, the bearing assembly can bear a large shear stress by means of the locking devices. Enlarging the diameter of the bolts for attaching the lower plate to the bottom base or for attaching the upper plate to the top plate is not needed. The bearing assembly can bear a larger shear stress with fewer bolts than a conventional bearing assembly. The cost to manufacture the bearing assembly with a high structural strength is reduced.

### BACKGROUND OF THE INVENTION

1. Field of the Invention

The present invention relates to a bearing assembly, and more particularly to a bearing assembly for a bridge and that can bear a larger shear stress than a conventional bearing assembly can.

2. Description of Related Art

A bridge is usually constructed with multiple decks and multiple piers to support the decks. At least one bearing assembly is attached to the bottom of each end of each deck to connect the deck to the pier. With reference to FIGS. 4 to 6, two fixed bearing assemblies (50) are generally secured to the bottom of one end of a deck (B), and two moveable bearing assemblies (60) are secured to the bottom of the other end of the deck (B) to allow the deck (B) to move relative to the pier (A). Consequently, the decks (B) can move slightly relative to the pier (A) to accommodate expansion of the deck (B) due to heat, contraction of the deck (B) due to cold and deformation or movement of the deck (B) due to earthquakes or other outside forces.

With reference to FIG. 5, a conventional fixed bearing assembly (50) in accordance with the prior art comprises a bottom base (51), a lower plate (55), an upper plate (56) and a top base (52). The bottom base (51) is securely attached to the top of the pier (A). The lower plate (55) is secured to the top of the bottom base (51) with bolts (53). The upper plate (56) is securely attached to the top of the lower plate (55). In practice, a recess (not numbered) is defined in the top of the lower plate (55), and a protrusion (not numbered) is integrally formed on the bottom of the upper plate (56) to engage the recess in the lower plate (55). Consequently, the upper plate (56) can be securely attached to the top of the lower plate (55) by means of the engagement between the protrusion and the recess. A resilient pad (57) is mounted in the recess the lower plate (55) and upper plate (56) to absorb shock applied to the bridge. The top base (52) is securely attached to the top of the upper plate (56) and is secured to the bottom of the deck (B). With the fixed bearing assembly (50), the deck (B) can be securely attached to the top of the pier (A).

With reference to FIG. 6, a conventional moveable bearing assembly (60) in accordance with the prior art comprises a bottom base (61), a lower plate (63), a I 11 medium base (66), a rail (69), an upper plate (65) and a top base (64). The bottom base (61) is securely attached to the top of the pier (A). The lower plate (63) is secured to the top of the bottom base (61) with bolts (62). The medium base (66) is securely attached to the top of the lower plate (63). In practice, a recess (not numbered) is defined in the top of the lower plate (63), and a protrusion (not numbered) is integrally formed on the bottom of the medium base (66) to engage with the recess in the lower plate (63). Consequently, the medium base (66) can be securely attached to the top of the lower plate (63) by means of the engagement between the protrusion and the recess. A resilient pad (67) is mounted in the recess between the lower plate (63) and medium base (66) to absorb shock applied to the bridge.

The rail (69) is firmly attached to the top of the medium base (66). The upper plate (65) is slidably mounted on the rail (69). The top base (64) is firmly attached to the top of the upper plate (65) with bolts (641) and is securely attached to the bottom of the deck (B). Accordingly, the top base (64) with the upper plate (65) can move relative to the medium base (66) along the rail (69). The end of the deck (B) with the moveable bearing assembly (60) can move relative to the pier (A) when the deck (B) expands due to heat, and contracts due to cold or deforms due to an external force such as an earthquake or the like. In addition, a low friction member (68) like a steel plate is mounted between the medium base (66) and the upper plate (65) to reduce the friction between the medium base (66) and the upper plate (65). A wear-resistant member (691) is mounted on each side of rail (69) to prevent wear of the rail (69).

With reference to FIGS. 4 and 5, when the deck (B) moves relative to the pier (A), the bolts (53, 54, 62, 641) attaching the lower plate (55, 63) to the bottom base (51, 61) and the upper plate (56, 65) to the top base (52, 64) will bear all the shear stress generated between the corresponding bases (51, 52, 61, 64) and plates (55, 56, 63, 65). To prevent the bolts (53, 54, 62, 641) from breaking and to enhance the structural strength of each bolt (53, 54, 62, 641), the diameter of each bolt (53, 54, 62, 641) is enlarged or the number of the bolts (53, 54, 62, 641) is increased. However, to enlarge the bottom base (51, 61), the sizes of the lower plate (55, 63), the upper plate (56, 65) and the top base (52, 64) also need to be increased to accommodate the larger diameter bolts (53,54,62,641). The material required to fabricate the bearing assembly (50, 60) is increased. Manufacturing the conventional bearing assembly (50,60) is expensive.

To overcome the shortcomings, the present invention tends to provide an improved bearing assembly to mitigate or obviate the aforementioned problems.

### SUMMARY OF THE INVENTION

The main objective of the invention is to provide an improved bearing assembly for a bridge and that can bear a larger shear stress with fewer bolts than the bolts in a conventional bearing assembly. The bearing assembly has a bottom base, a lower plate, an upper plate and a top base. At least one first locking device is configured between the lower plate and the bottom base. At least one second locking device is configured between the upper plate and the top base. With such an arrangement, the bearing assembly can bear a large shear stress applied to the bearing assembly by means of the locking devices mounted in the bearing assembly. Enlarging the diameter of the bolt attaching the lower plate to the bottom base or the upper plate to the top plate is not needed. The cost of manufacturing the bearing assembly with a high structural strength is reduced.

Other objects, advantages and novel features of the invention will become more apparent from the following detailed description when taken in conjunction with the accompanying drawings.

### BRIEF DESCRIPTION OF THE DRAWINGS

FIG. 1 is an exploded cross sectional perspective view of a bearing assembly in accordance with the present invention;

FIG. 2 is a transverse cross sectional plan view of the bearing assembly in FIG. 1 mounted between the deck and the pier of a bridge;

FIG. 3 is an exploded cross sectional perspective view of another embodiment of a bearing assembly in accordance with the present invention;

FIG. 4 is a bottom view of two bridge decks with conventional bearing assemblies in accordance with the prior art;

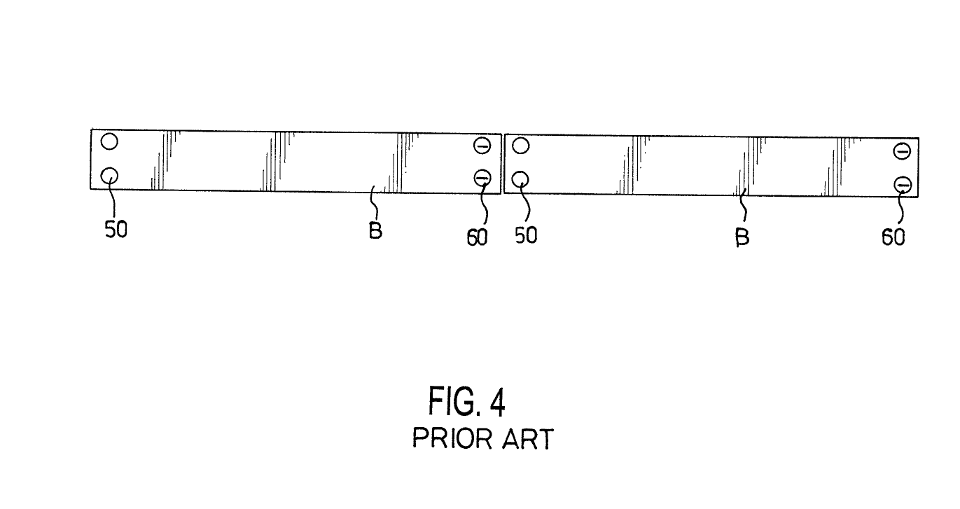

FIG. 5 is a perspective view in partial section of a conventional fixed bearing assembly in FIG. 4; and

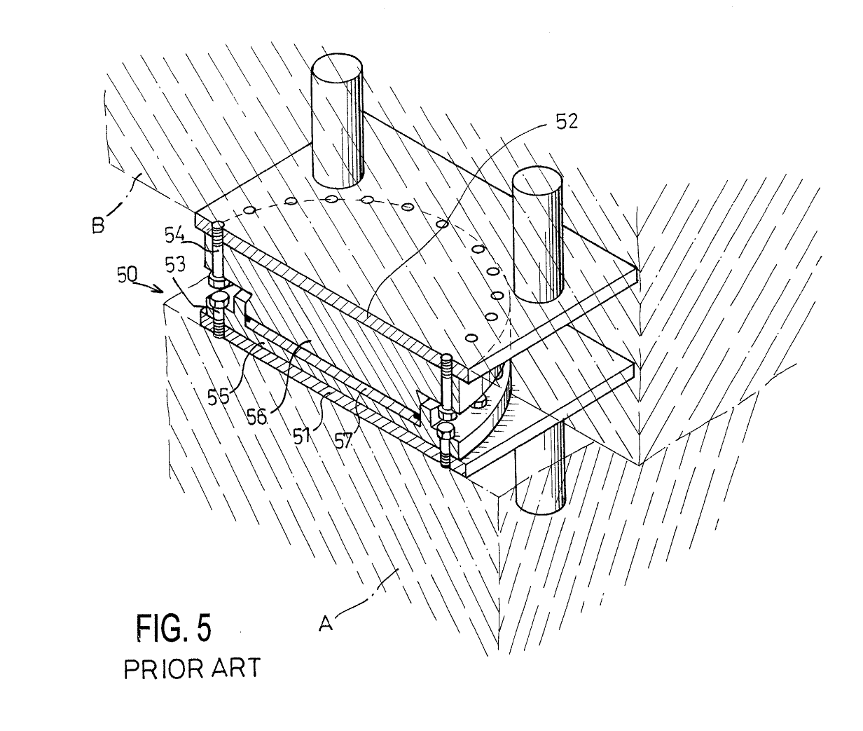

FIG. 6 is a perspective view in partial section of the conventional moveable bearing assembly in FIG. 4.

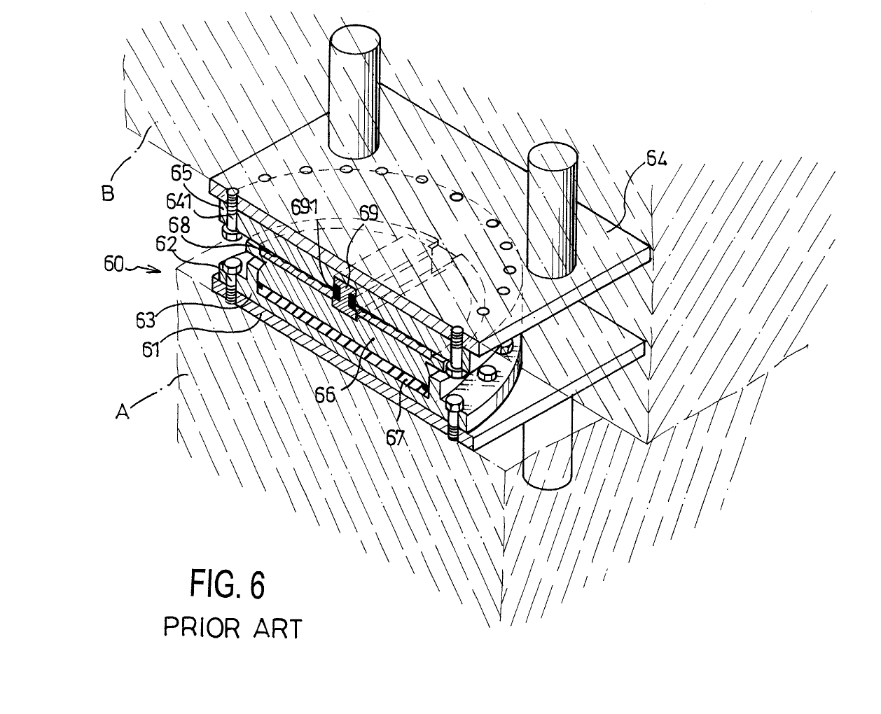

### DETAILED DESCRIPTION OF PREFERRED EMBODIMENT

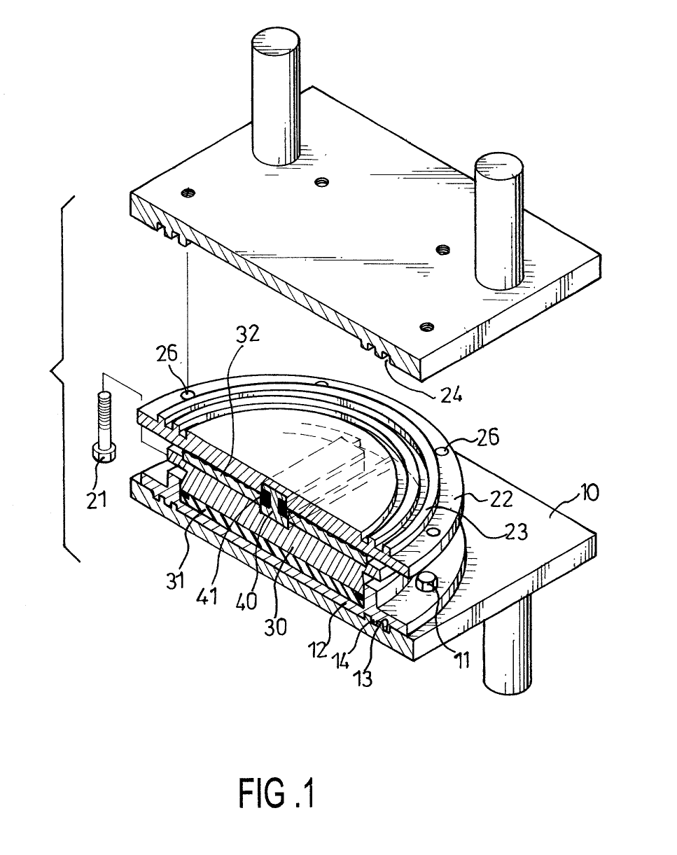

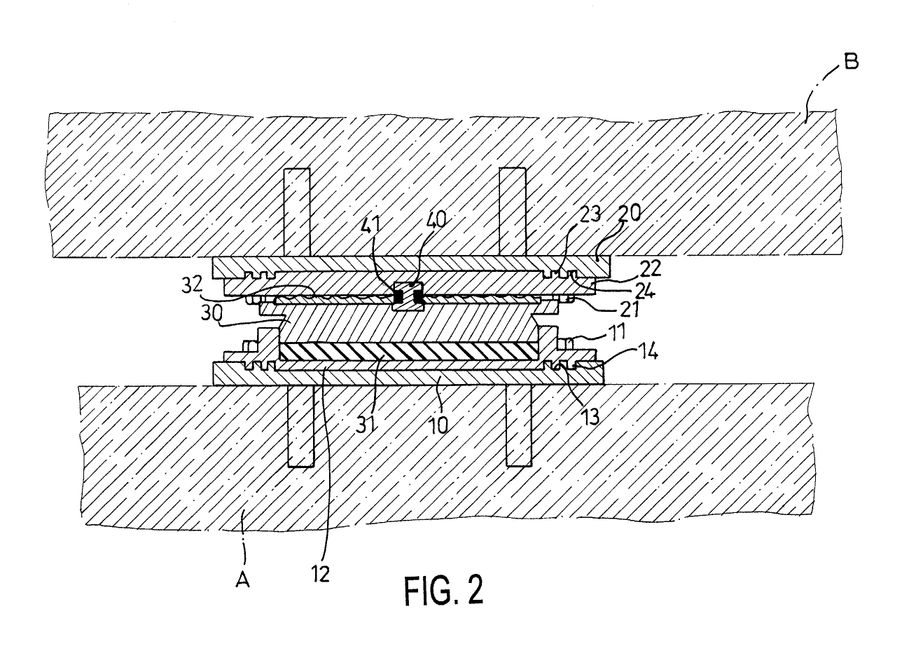

With reference to FIGS. 1 and 2, a bearing assembly for a bridge in accordance with the present invention comprises a bottom base (10), a lower plate (12), an upper plate (22) and a top base (20). The bridge is constructed with at least one deck (B) and multiple piers (A). Each deck (B) has a top, a bottom and two ends. Each pier (A) has a top corresponding to the bottom of one end of each deck (B). All the bottom bases (10), lower plates (12), upper plates (22) and top base (20) have a top and a bottom. The bottom base (10) is securely attached to the top of one pier (A) of a bridge. The lower plate (12) is securely attached to the top of the bottom base (10) with bolts (11). At least one first locking device is configured between the lower plate (12) and the bottom base (10). Each first locking device comprises a series of circular lands and grooves (13) defined in the top of the bottom base (10) and a complementary series of circular lands and grooves (14) formed on the bottom of the lower plate (12) to engage with the lands and grooves (13) in the bottom base (10).

With reference to FIGS. 1 and 2, a medium base (30) is securely attached to the top of the lower plate (12) of the moveable bearing assembly. A recess (not numbered) is defined in the top of the lower plate (12), and a protrusion (not numbered) is integrally formed on the bottom of the medium base (30) to engage with the recess in the lower plate (12). The medium base (30) can be securely attached to the top of the lower plate (12) by means of the engagement between the protrusion and the recess. A resilient pad (31) is is mounted in the recess between the lower plate (12) and medium base (30) to absorb shock applied to the bridge. A rail (40) is firmly attached to the top of the medium base (30).

The upper plate (22) is slidably attached to the rail (40). The top base (20) is securely attached to the top of the upper plate (22) with bolts (21) and is firmly attached to the bottom of the deck (B) of the bridge. Consequently, the top base (20) with the upper plate (22) can move relative to the medium base (30) along the rail (40). A low friction member (32) like a steel plate is mounted between the medium base (30) and the upper plate (22) to reduce the friction between the medium base (30) and the upper plate (22). A wear-resistant member (41) is mounted on each side of the rail (40) to prevent the rail (40) from wearing as the upper plate (22) moves along the rail (40). [NOTE: The “wear-resistant member (41)” is not included in the claims and should at least provide some example to allow people understand what it might be.]

At least one second locking device is configured between the upper plate (22) and the top base (20). Each second locking device comprises a series of circular lands and grooves (24) defined in the bottom of the top base (20) and a complementary series of circular lands and grooves (23) formed on the top of the upper plate (22) to engage with the lands and grooves (24) in the top base (20).

The first locking devices and the second locking devices improve the strength of the connection between the bottom base (10) and the lower plate (12) and the upper plate (22) and the top base (20). When the deck (B) moves or shock is applied to the bridge, the first locking device or the second devices can bear the shear stress generated between the corresponding base (10, 20) and plate (12, 22). The locking devices will take a share of the shear stress originally applied to the bolts (11, 21), so that the shear stress applied to each bolt (11, 21) is reduced. Consequently, the bearing assembly can bear an equivalent or larger shear stress generated between the corresponding base (10, 20) and plate (12, 22) even through the diameter of each bolt (11,21) is decreased. Therefore, the bearing assembly can bear a large shear stress applied to the bearing assembly with less bolts (11,21) than a conventional bearing assembly by means of the locking devices configured in the bearing assembly. In addition, enlarging the bases (10, 20), plates (12, 22) and bolts (11, 21) is not needed, and the cost of manufacturing a bearing assembly with a high structural strength to bear the shear stress is reduced.

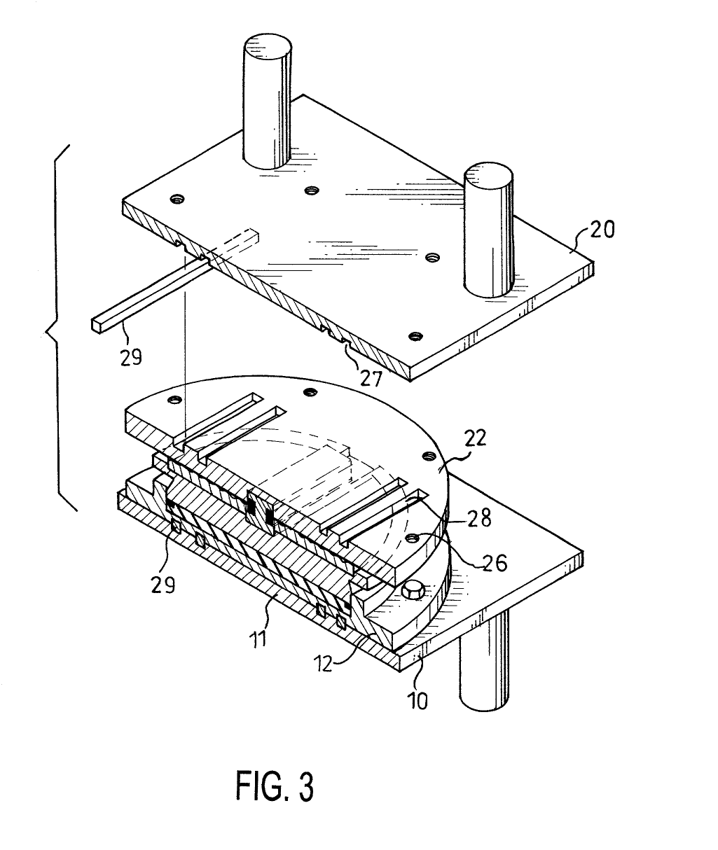

With reference to FIG. 3, another embodiment of a first locking device comprises a first keyway (not numbered), a second keyway (not numbered) and a key (29). The first keyway is defined in the top of the bottom base (10). The second keyway is defined in the bottom of the lower plate (12) and aligns with the first keyway in the bottom base (10). The key (29) is simultaneously engaged in the first keyway in the bottom base (10) and the second keyway in the lower plate (12).

Each second locking device comprises a first keyway (27), a second keyway (28) and a key (29). The first keyway (27) is defined in the bottom of the top base (20). The second keyway (28) is defined in the top of the upper plate (22) and aligns with the first keyway (27) in the top base (20). The key (29) is simultaneously engaged in the first keyway (27) in the top base (20) and the second keyway (28) in the upper plate (22). The first locking devices and the second locking devices can also enhance the structural strength of the bearing assembly to bear the shear stress.

Furthermore, in a fixed bearing assembly, the upper plate (22) is securely attached to the top of the lower plate (12). At least one first locking device is configured between the lower plate (12) and the bottom base (10). At least one second locking device is configured between the upper plate (22) and the top base (20). The fixed bearing assembly with the locking devices can also bear a large shear stress without enlarging the diameter of the bolts (11, 21).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bearing assembly for a bridge having multiple decks each with a top, bottom and two ends and at least one pier having a top and corresponding to one end of one of the decks to support the decks, the bearing assembly comprising:
a bottom base with a top and a bottom adapted to be secured to the top of at least one pier of the bridge;
a lower plate with a top and a bottom securely attached to the top of the bottom base;
an upper plate with a top and a bottom attached to the top of the lower plate; and
a top base with a top and a bottom securely attached to the top of the upper plate and adapted to be securely attached to the bottom of one end of the decks of the bridge,
wherein at least one first locking device is configured between the lower plate and the bottom base; and
at least one second locking device is configured between the upper plate and the top base,
whereby the bearing assembly can bear a large shear stress applied to the bearing assembly by means of the locking devices configured in the bearing assembly.

2. The bearing assembly as claimed in claim 1, wherein each at least one first locking device comprises:
a series of lands and grooves defined in a top of the bottom base; and
a complementary series of lands and grooves formed on a bottom of the lower plate to engage with the lands and grooves in the bottom base.

3. The bearing assembly as claimed in claim 2, wherein the lands and grooves of each at least one first locking device are circular.

4. The bearing assembly as claimed in claim 1, wherein each at least one second locking device comprises:
a series of lands and grooves defined in a bottom of the top base; and
a complementary series of lands and grooves formed on a top of the upper plate to engage with the lands and grooves in the top base.

5. The bearing assembly as claimed in claim 4, wherein the lands and grooves of each at least one second locking device are circular.

6. The bearing assembly as claimed in claim 1, wherein each at least one first locking device comprises:
a first keyway defined in a top of the bottom base;
a second keyway defined in a bottom of the lower plate and aligning with the first keyway in the bottom base; and
a key simultaneously engaged in the first keyway in the bottom base and the second groove in the lower plate.

7. The bearing assembly as claimed in claim 1, wherein each at least one second locking device comprises:
a first keyway defined in a bottom of the top base;
a second keyway defined in a top of the upper plate and aligning with the first keyway in the top base; and
a key simultaneously engaged in the first keyway in the top base and the second keyway in the upper plate.

8. The bearing assembly as claimed in claim 1, wherein the upper plate is moveably attached to the lower plate,
wherein a medium base is securely attached to the top of the lower plate; and
a rail is securely attached to the medium base and slidably attached to a bottom of the upper plate.

9. The bearing assembly as claimed in claim 8 further comprising a resilient pad mounted between the lower plate and the medium base to absorb shock applied to the bridge.

10. The bearing assembly as claimed in claim 8 further comprising a low friction member mounted between the medium base and the upper plate to reduce friction between the medium base and the upper plate.

11. The bearing assembly as claimed in claim 1 further comprising a resilient pad mounted between the lower plate and the upper plate to absorb shock applied to the bridge.
